(19) United States
(12) Patent Application Publication
(10) Pub. No.: US 2012/0228561 A1
(43) Pub. Date: Sep. 13, 2012

(54) PRODUCTION METHOD FOR LITHIUM ION SECONDARY BATTERY POSITIVE ELECTRODE MATERIAL

(75) Inventors: Tomohiro Nagakane, Otsu-shi (JP); Akihiko Sakamoto, Otsu-shi (JP); Tsuyoshi Honma, Nagaoka-Shi (JP); Takayuki Komatsu, Nagaoka-Shi (JP)

(73) Assignees: NATIONAL UNIVERSITY CORPORATION NAGAOKA UNIVERSITY OF TECHNOLOGY, Niigata (JP); NIPPON ELECTRIC GLASS CO., LTD., Otsu-shi, Shiga (JP)

(21) Appl. No.: 13/509,980

(22) PCT Filed: Nov. 11, 2010
(86) PCT No.: PCT/JP2010/070122

§ 371 Date: May 15, 2012

(30) Foreign Application Priority Data
Nov. 16, 2009 (JP) 2009-260834

(51) Int. Cl. H01M 4/58; C03B 27/012; C03C 6/04; H01B 1/08; C03C 6/00

(52) U.S. Cl. 252/519.14; 501/27; 501/31; 65/137; 65/33.1; 65/32.3

(57) ABSTRACT

Provided is the method for producing, by heat treating raw material powder, a lithium ion secondary battery positive electrode material which contains an olivine-structure crystal represented by general formula LiMₓFe₁₋ₓPO₄ (where 0≦x<1 and M is at least one type selected from Nb, Ti, V, Cr, Mn, Co and Ni), wherein the raw material powder contains trivalent iron compound. The present invention allows for stably producing at reduced cost a lithium ion secondary battery positive electrode material which contains olivine-type LiMₓFe₁₋ₓPO₄ crystal.

### TECHNICAL FIELD

The present invention relates to a production method for a lithium ion secondary battery positive electrode material to be used for a portable electronic device and an electric vehicle.

### BACKGROUND ART

Lithium ion secondary batteries have been essential as high-capacity and lightweight power supplies for mobile electronic terminals and electric vehicles. As a positive electrode material for lithium ion secondary batteries, an inorganic metal oxide such as lithium cobalt oxide (LiCoO₂) or lithium manganese oxide (LiMnO₂) has been heretofore used. In recent years electronic devices have been more and more enhanced in their performances and in accordance therewith the power consumption has also been increased, so that it is required to achieve higher capacity in lithium ion secondary batteries. In addition, from view points of environment conservation issue and energy dispute, it is desired to shift from materials such as Co and Mn with severe environmental burden to more environment-conscious materials. Also from a view point that depletion of cobalt resources is problematic, it is desired to shift to inexpensive positive electrode materials substitute for LiCoO₂.

Recently, among lithium compounds which contain iron, olivine-type LiMₓFe₁₋ₓPO₄ (where 0≦x<1 and M is at least one type selected from Nb, Ti, V, Cr, Mn, Co and Ni) crystal attracts attention because of advantages to cost and resources, and various kinds of research and development are carried on (refer to Patent Document 1, for example). Olivine-type LiMₓFe₁₋ₓPO₄ is excellent in temperature stability compared to that of LiCoO₂ and safe operation is expected at high temperature. It also has a feature that high resistance properties to structural deterioration due to charge and discharge reactions are obtained because the structure has phosphoric acid as its framework.

### PRIOR ART DOCUMENTS

Patent Document 1: Published Patent Application (Kokai) No. H9-134725

### SUMMARY OF THE INVENTION

### Problem to be Solved by the Invention

Olivine-type LiMₓFe₁₋ₓPO₄ crystal is usually produced by heat treating raw material powder which contains divalent iron compound such as iron oxalate. However, there are few divalent iron compound which can be stably mass-produced and the material cost thus tends to be high.

The present invention has been made in consideration of such circumstances, and an object thereof is to provide a method for stably producing at low cost a lithium ion secondary battery positive electrode material which contains olivine-type LiMₓFe₁₋ₓPO₄ crystal.

### Means for Solving the Problems

As a result of intensive studies, the present inventors have found out that the previously-described problems are solved by using as a starting substance an iron compound which is more stable than the conventional divalent iron compound such as iron oxalate and propose hereby as the present invention.

That is, the present invention relates to a method for producing, by heat treating raw material powder, a lithium ion secondary battery positive electrode material which contains an olivine-structure crystal represented by the general formula LiMₓFe₁₋ₓPO₄ (where 0≦x<1 and M is at least one type selected from Nb, Ti, V, Cr, Mn, Co and Ni), wherein the raw material powder contains trivalent iron compound.

Conventionally, divalent iron compound such as iron oxalate has been used as raw material powder because the Fe component in olivine-structure crystal represented by the general formula LiMₓFe₁₋ₓPO₄ is comprised of divalent Fe. According to the present invention, the trivalent iron compound, which is more stable and inexpensive, is used as raw material powder thereby to allow for stably producing at reduced cost a lithium ion secondary battery positive electrode material which contains olivine-type LiMₓFe₁₋ₓPO₄ crystal.

Second, in the production method for a lithium ion secondary battery positive electrode material according to the present invention, the trivalent iron compound is Fe₂O₃.

Fe₂O₃ is preferred because it is inexpensive and easy to be handled among trivalent iron compounds.

Third, the production method for a lithium ion secondary battery positive electrode material according to the present invention includes the steps of (1) preparing a batch to contain at least Li₂O, Fe₂O₃ and P₂O₅ thereby to obtain raw material powder, (2) melting the raw material powder to obtain a molten glass, and (3) rapidly quenching the molten glass to obtain a precursor glass.

Although solid-phase reaction, hydrothermal synthesis, microwave heating and other methods are conventionally known as production methods for olivine type LiMₓFe₁₋ₓPO₄, these methods remain problematic in terms of productivity and powder particle diameter control. Accordingly, melting and rapid quenching method is employed to produce a precursor glass thereby providing a simple method with high productivity in which powder particle diameter can be easily controlled. In addition, according to that method, the precursor glass can be obtained in which components including lithium, phosphorus and iron are homogeneously mixed, and in a subsequent step, a dense positive electrode material may readily be obtained where a desired amount of LiMₓFe₁₋ₓPO₄ crystal precipitates.

Fourth, in the production method for a lithium ion secondary battery positive electrode material according to the present invention, the step (1) includes preparing a batch to contain a composition of Li₂O: 20 to 50%, Fe₂O₃: 10 to 40% and P₂O₅: 20 to 50% in equivalent oxide mol % indication.

Fifth, in the production method for a lithium ion secondary battery positive electrode material according to the present invention, the step (1) includes preparing a batch to further contain a composition of Nb₂O₅+V₂O₅+SiO₂+B₂O₃+GeO₂+Al₂O₃+Ga₂O₃+Sb₂O₃+Bi₂O₃: 0.1 to 25% in equivalent oxide mol % indication.

The above components act to improve the glass forming ability, and adding these components thus enables to obtain a chemically stable positive electrode material.

Sixth, the production method for a lithium ion secondary battery positive electrode material according to the present invention further includes the steps of (4) crushing the obtained precursor glass to obtain precursor glass powder and (5) firing the precursor glass powder at a temperature within the range from the glass-transition temperature to 1,000° C. to obtain crystallized glass powder.

Seventh, in the production method for a lithium ion secondary battery positive electrode material according to the present invention, the step (5) includes adding carbon or organic compound to the precursor glass powder and then performing the firing in an inert or reductive atmosphere.

That feature allows the olivine-structure crystal represented by the general formula LiMₓFe₁₋ₓPO₄ to be selectively obtained because the trivalent Fe component in the glass is reduced to divalent when crystallizing the glass powder in that atmosphere.

Eighth, the present invention relates to a lithium ion secondary battery positive electrode material produced by either one of the previously-described production methods.

Ninth, the present invention relates to a precursor glass for a lithium ion secondary battery positive electrode material, wherein the precursor glass contains a composition of Li₂O: 20 to 50%, Fe₂O₃: 10 to 40% and P₂O₅: 20 to 50% in equivalent oxide mol % indication and the concentration ratio Fe²⁺/Fe³⁺ in the glass is within the range from 0.05 to 1.5.

In the precursor for a lithium ion secondary battery positive electrode material, by adjusting the concentration ratio Fe²⁺/Fe³⁺ in the glass within the above range, the stability of glass is enhanced and a desired amount of the LiMₓFe₁₋ₓPO₄ crystal is allowed to precipitate by the crystallization process.

Note that the “precursor glass” refers to a glass able to be crystallized by being subjected to a heat treatment to precipitate a target crystal.

Tenth, the precursor glass for a lithium ion secondary battery positive electrode material according to the present invention further contains a composition of Nb₂O₅+V₂O₅+SiO₂+B₂O₃+GeO₂+Al₂O₃+Ga₂O₃+Sb₂O₃+Bi₂O₃: 0.1 to 25% in equivalent oxide mol % indication.

Eleventh, the present invention relates to a lithium ion secondary battery positive electrode material obtained by crystallizing either one of the previously-described precursor glasses for lithium ion secondary battery positive electrode material.

### DESCRIPTION OF EMBODIMENTS

The production method for a lithium ion secondary battery positive electrode material according to the present invention is a method for producing, by heat treating raw material powder, a lithium ion secondary battery positive electrode material which contains as a main ingredient a crystal represented by the general formula LiMₓFe₁₋ₓPO₄ (where 0≦x<1 and M is at least one type selected from Nb, Ti, V, Cr, Mn, Co and Ni), wherein the raw material powder contains trivalent iron compound. As previously described, because the trivalent iron compound is more stable and inexpensive compared to the conventional divalent iron compound such as iron oxalate, it is possible to produce at reduced cost a lithium ion secondary battery positive electrode material which contains olivine-type LiMₓFe₁₋ₓPO₄ crystal.

As the trivalent iron compound, Fe₂O₃ (iron (III) oxide) is preferred in view of its cost and easy handling. Alternatively or additionally, Fe₃O₄ may be used.

It is preferred that the production method for a lithium ion secondary battery positive electrode material according to the present invention includes a glass melting process. Specifically, the production method for a lithium ion secondary battery positive electrode material according to the present invention preferably includes the steps of (1) preparing a batch to contain at least Li₂O, Fe₂O₃ and P₂O₅ thereby to obtain raw material powder, (2) melting the raw material powder to obtain a molten glass, and (3) rapidly quenching the molten glass to obtain a precursor glass. According to that production method, the precursor glass can be obtained in which components including lithium, phosphorus and iron are homogeneously mixed, and in a subsequent step, LiMₓFe₁₋ₓPO₄ crystal may readily be obtained.

In the step (1), it is preferred that a batch is prepared to contain a composition of Li₂O: 20 to 50%, Fe₂O₃: 10 to 40% and P₂O₅: 20 to 50% in equivalent oxide mol % indication

The reason that the composition is selected as the above will be described below.

Li₂O is a main constituent of LiMₓFe₁₋ₓPO₄. It is preferred that the content of Li₂O is 20 to 50%, and particularly preferred is 25 to 45%. If the content of Li₂O is less than 20% or more than 50%, then LiMₓFe₁₋ₓPO₄ crystal will be hard to precipitate when firing the obtained precursor glass.

Fe₂O₃ is also a main constituent of LiMₓFe₁₋ₓPO₄. It is preferred that the content of Fe₂O₃ is 10 to 40%, and particularly preferred is 15 to 35%. If the content of Fe₂O₃ is less than 10% or more than 40%, then LiMₓFe₁₋ₓPO₄ crystal will be hard to precipitate when firing the obtained precursor glass.

P₂O₅ is yet also a main constituent of LiMₓFe₁₋ₓPO₄. It is preferred that the content of P₂O₅ is 20 to 50%, and particularly preferred is 25 to 45%. If the content of P₂O₅ is less than 20% or more than 50%, then LiMₓFe₁₋ₓPO₄ crystal will be hard to precipitate when firing the obtained precursor glass.

In the step (1), it is preferred that a batch further contains a composition of Nb₂O₅+V₂O₅+SiO₂+B₂O₃+GeO₂+Al₂O₃+Ga₂O₃+Sb₂O₃+Bi₂O₃: 0.1 to 25% in equivalent oxide mol % indication.

Nb₂O₅, V₂O₅, SiO₂, B₂O₃, GeO₂, Al₂O₃, Ga₂O₃, Sb₂O₃ and Bi₂O₃ are constituents for improving the glass forming ability. If the total amount of contents of the above oxides is less than 0.1%, then vitrification is difficult. Whereas if the total amount of contents of the above oxides is more than 25%, then the fraction of LiMₓFe₁₋ₓPO₄ crystal to be obtained by firing may possibly be decreased.

Note that the concentration ratio (molar ratio) Fe²⁺/Fe³⁺ affects the stability of the precursor glass. It is preferred that the concentration ratio Fe²⁺/Fe³⁺ is 0.05 to 1.5, further preferred is 0.1 to 1.2, and particularly preferred is 0.2 to 1.0. If the concentration ratio Fe²⁺/Fe³⁺ is less than 0.05, then the amount of LiMₓFe₁₋ₓPO₄ crystal to precipitate in the subsequent firing step may possibly decrease. While if the concentration ratio Fe²⁺/Fe³⁺ is more than 1.5, then the glass tends to be unstable. The concentration ratio Fe²⁺/Fe³⁺ may be adjusted by appropriately changing the contents ratio of divalent iron compound and trivalent iron compound in the raw material powder.

In addition, it is preferred that the production method for a lithium ion secondary battery positive electrode material according to the present invention further includes, subsequent to the above steps (1) to (3) , the steps of (4) crushing the obtained precursor glass to obtain precursor glass powder and (5) firing the precursor glass powder at a temperature within the range from the glass-transition temperature to 1,000° C. to obtain crystallized glass powder. This allows for efficiently obtaining a lithium ion secondary battery positive electrode material comprised of the crystallized glass powder which contains LiMₓFe₁₋ₓPO₄ crystal.

The firing the precursor glass powder is performed by heat treating in an electrical furnace in which the temperature and the atmosphere are controllable, for example. Although the heat treating temperature is not particularly limited because the temperature history for the heat treating varies depending on the composition of the precursor glass and the target crystallite size, it is appropriate that the heat treating is performed at least at the glass-transition temperature or higher, and further preferably at the crystallization temperature or higher. The upper limit is 1,000° C., furthermore 950° C. If the heat treating temperature is lower than the glass-transition temperature, then the generation and the growth of LiMₓFe₁₋ₓPO₄ crystal will be insufficient thereby possibly not to provide the advantage of sufficiently improving the conductivity. On the other hand, if the heat treating temperature exceeds 1,000° C., then the crystal will possibly be molten. It is thus preferred that the specific temperature range of heat treating is 500 to 1,000° C., and particularly preferred is 550 to 950° C. The heat treating time is appropriately adjusted such that the precursor glass sufficiently undergoes crystallization. Specifically, it is preferred that the heat treating time is 10 to 60 minutes, and particularly preferred is 20 to 40 minutes.

As the particle diameter of the crystallized glass powder decreases, the surface area of the entire positive electrode material increases to facilitate the exchange of ions or electrons, and the reduced particle diameter is thus preferred. Specifically, it is preferred that the average particle diameter of the crystallized glass powder is 50 μm or less, more preferred is 30 μm or less, and most preferred is 20 μm or less. While the lower limit is not particularly limited, it is actually 0.05 μm or more. The particle diameter of the crystallized glass powder is measured by laser diffractometry.

As the crystallite size of LiMₓFe₁₋ₓPO₄ crystal in the crystallized glass powder decreases, the particle diameter of the crystallized glass powder may correspondingly decrease thereby to improve the electrical conductivity. Specifically, it is preferred that the crystallite size is 100 nm or less, and particularly preferred is 80 nm or less. While the lower limit is not particularly limited, it is actually 1 nm or more, furthermore 10 nm or more. Note that the crystallite size is obtained in accordance with Scherrer's equation using results from powder X-ray diffraction analysis for the crystallized glass powder.

It is preferred that the crystal amount of LiMₓFe₁₋ₓPO₄ in the crystallized glass powder is 20 mass % or more, more preferred is 50 mass % or more, and further preferred is 70 mass % or more. If the crystal amount is less than 20 mass %, then the conductivity tends to be insufficient. Note that, although the upper limit is not particularly limited, it is actually 99 mass % or less, furthermore 95 mass % or less. The crystal amount of LiMₓFe₁₋ₓPO₄ may be calculated from a peak strength area ratio in powder X-ray diffraction patterns.

In the step (5), it is preferred that carbon or organic compound is added to the precursor glass powder to perform the firing in an inert or reductive atmosphere. Carbon or organic compound is subjected to the firing to exhibit reductive action thereby causing the valency of iron in the glass to change from trivalent to divalent before the glass powder is crystallized, and LiMₓFe₁₋ₓPO₄ is thus obtained with high content percentage.

Carbon and organic compound also act as electron-conduction active materials for imparting conductivity to the crystallized glass powder. As carbon, graphite, acetylene black, amorphous carbon etc. may be mentioned. Note that, as the amorphous carbon, such that the FTIR analysis thereof shows substantially no C—O bond peak and C—H bond peak because they cause conductivity degradation in the positive electrode material is preferred. As organic compound, calboxylic acid such as aliphatic carboxylic acid and aromatic carboxylic acid, glucose and organic binder etc. may be mentioned.

The electrical conductivity of the lithium ion secondary battery positive electrode material according to the present invention is 1.0×10⁻⁸ S.cm⁻¹ or more, preferably 1.0×10⁻⁶ S.cm⁻¹ or more, and further preferably 1.0×10⁻⁴ S.cm⁻¹ or more.

### EXAMPLES

While the present invention is more specifically described hereinafter with reference to examples, the present invention is not limited to these examples.

### Example 1

Using raw material of lithium metaphosphate (LiPO₃), lithium carbonate (Li₂CO₃), iron (III) oxide (Fe₂O₃) and niobium oxide (Nb₂O₅), raw material powder was prepared with composition of 31.7% Li₂O, 31.7% Fe₂O₃, 31.7% P₂O₅ and 4.8% Nb₂O₅ in mol %, and molten at 1,200° C. for one hour in air atmosphere. Thereafter, rapid press quenching was performed to produce a sample of precursor glass.

Valency status of iron ion in the produced precursor glass was measured by Mossbauer spectroscopy. As a result, the ratio Fe²⁺/Fe³⁺ was determined as being 0.22.

### Comparative Example 1

Using raw material of lithium metaphosphate (LiPO₃), lithium carbonate (Li₂CO₃), iron (II) oxide (FeO) and niobium oxide (Nb₂O₅), raw material powder was prepared with composition of 31.7% Li₂O, 31.7% 2FeO, 31.7% P₂O₅ and 4.8% Nb₂O₅ in mol %, and molten at 1,200° C. for one hour in nitrogen atmosphere. Thereafter, rapid press quenching was performed, but devitrification occurred in the obtained glass. Valency status of iron ion in this substance was measured and the ratio Fe²⁺/Fe³⁺ was determined as being 2.7.

### Example 2

The precursor glass produced in the method of Example 1 was crushed using a ball mill to obtain precursor glass powder, and 100 parts by mass of the obtained precursor glass powder was mixed thereto with 30 parts by mass of acrylic resin (polyacrylonitrile) as organic binder (equivalent to 18.9 parts by mass of graphite), 3 parts by mass of butyl benzyl phthalate as plasticizer and 35 parts by mass of methyl ethyl ketone as solvent, thereby to be slurry. The slurry was formed into sheet shape with thickness of 200 μm by known doctor blade method, and then dried at room temperature for about 2 hours. Subsequently, the sheet-shaped formed body was cut with predetermined dimensions and subjected to heat treating at 800° C. for 30 minutes in nitrogen gas. Obtained sample had a structure in which the crystallized glass powders were bonded together via carbon components.

After checking the powder X-ray diffraction patterns of the obtained sample, diffraction lines derived from LiMₓFe₁₋ₓPO₄ were found out to be confirmed. In addition, LiMₓFe₁₋ₓPO₄ crystallite size obtained using Scherrer' s equation from the powder X-ray diffraction patterns is evaluated as being 20 to 60 nm.

1. A method for producing, by heat treating raw material powder, a lithium ion secondary battery positive electrode material which contains an olivine-structure crystal represented by general formula LiMₓFe₁₋ₓPO₄ (where 0≦x<1 and M is at least one type selected from Nb, Ti, V, Cr, Mn, Co and Ni), wherein the raw material powder contains trivalent iron compound.

2. The production method for a lithium ion secondary battery positive electrode material as set forth in claim 1, wherein the trivalent iron compound is Fe₂O₃.

3. The production method for a lithium ion secondary battery positive electrode material as set forth in claim 1, comprising the steps of (1) preparing a batch to contain at least Li₂O, Fe₂O₃ and P₂O₅ thereby to obtain raw material powder, (2) melting the raw material powder to obtain a molten glass, and (3) rapidly quenching the molten glass to obtain a precursor glass.

4. The production method for a lithium ion secondary battery positive electrode material as set forth in claim 3, wherein the step (1) includes preparing a batch to contain a composition of Li₂O: 20 to 50%, Fe₂O₃: 10 to 40% and P₂O₅: 20 to 50% in equivalent oxide mol % indication.

5. The production method for a lithium ion secondary battery positive electrode material as set forth in claim 3, wherein the step (1) includes preparing a batch to further contain a composition of Nb₂O₅+V₂O₅+SiO₂+B₂O₃+GeO₂+Al₂O₃+Ga₂O₃+Sb₂O₃+Bi₂O₃: 0.1 to 25% in equivalent oxide mol % indication.

6. The production method for a lithium ion secondary battery positive electrode material as set forth claim 3, further comprising the steps of (4) crushing the obtained precursor glass to obtain precursor glass powder and (5) firing the precursor glass powder at a temperature within range from glass-transition temperature to 1,000° C. to obtain crystallized glass powder.

7. The production method for a lithium ion secondary battery positive electrode material as set forth in claim 6, wherein the step (5) includes adding carbon or organic compound to the precursor glass powder and then performing the firing in an inert or reductive atmosphere.

8. A lithium ion secondary battery positive electrode material produced by the method as set forth in any one of claims 1.

9. A precursor glass for a lithium ion secondary battery positive electrode material contains a composition of Li₂O: 20 to 50%, Fe₂O₃: 10 to 40% and P₂O₅: 20 to 50% in equivalent oxide mol % indication and has the concentration ratio Fe²⁺/Fe³⁺ in the glass within range from 0.05 to 1.5.

10. The precursor glass for a lithium ion secondary battery positive electrode material as set forth in claim 9, which further contains a composition of Nb₂O₅+V₂O₅+SiO₂+B₂O₃+GeO₂+Al₂O₃+Ga₂O₃+Sb₂O₃+Bi₂O₃: 0.1 to 25% in equivalent oxide mol % indication.

11. A lithium ion secondary battery positive electrode material obtained by crystallizing the precursor glass for a lithium ion secondary battery positive electrode material as set forth in claim 9.
